(19) United States
(12) Patent Application Publication
(10) Pub. No.: US 2025/0018517 A1
(43) Pub. Date: Jan. 16, 2025

(54) SYSTEM AND METHOD OF PROCESSING ALUMINUM ALLOY

(71) Applicant: COMPTAKE TECHNOLOGY INC., NEW TAIPEI CITY (TW)

(72) Inventors: YAO-GUANG YANG, NEW TAIPEI CITY (TW); KUEN-CHIH LAN, NEW TAIPEI CITY (TW); ZHI WEN FAN, NEW TAIPEI CITY (TW); CHAO-CHANG CHEN, NEW TAIPEI CITY (TW)

(21) Appl. No.: 18/710,183

(22) PCT Filed: Nov. 15, 2022
(86) PCT No.: PCT/CN2022/131848

§ 371 Date: May 15, 2024

Related U.S. Application Data
(60) Provisional application No. 63/279,261, filed on Nov. 15, 2021.

(51) Int. Cl. B24B 7/20

(52) U.S. Cl. CPC B24B 7/20

(57) ABSTRACT

A work piece processing system includes a grinding wheel (12) configured to remove material from a work piece in a grinding process. The grinding wheel (12) includes a conductive layer (122) surrounding a rotation axis of the grinding wheel (12) and a number of grinding members (123) positioned at an outer surface of the conductive layer (122). The system also includes a holding module (20) and an electrolyte supply line (365). In addition, the system includes an actuator assembly (30) for driving a rotation of the grinding wheel (12) and a rotation of the holding module (20), and a power supply module (45) to apply current to the conductive layer (122) and the holding module (20). The work piece processing system uses electrochemical removal to reduce grinding damage and improve machining efficiency. A work piece processing method is also provided.

### PRIORITY CLAIM

This application is a 371 application of the International Patent Application No. PCT/CN2022/131848 filed 15 Nov. 2022, which claims the priority of U.S. Provisional Application No. 63/279,261, filed 15 Nov. 2021, the disclosures of which are hereby incorporated by reference herein in their entireties.

### FIELD OF THE INVENTION

Embodiments of present disclosure relate to a system and a method that are used for processing a workpiece made of aluminum alloy such as aluminum silicon carbide (AlSiC).

### BACKGROUND

Aluminum and its alloys are commonly used in industry due to their lightness, and high strength/weight ratio. For example, aluminum silicon carbide (AlSiC) materials have a unique set of material properties that are ideally suited for electronic packaging applications requiring thermal management solutions. The AlSiC coefficient of thermal expansion (CTE) values is compatible with direct integrated circuit device attachment to the maximum thermal dissipation. The low material density of AlSiC makes it ideal for weight sensitive applications such as portable devices. Structural packaging requirements are satisfied by the material strength and stiffness that is both approximately three times greater than AI-metal. Additionally, AlSiC is a hermetic material that can be used to give protection against environmentally sensitive electronic components. Also, this composite material is electronically conductive providing EMI/RFI shielding.

Various machining operations such as turning, drilling, milling and threading are used in order to be manufactured in desired forms in a conventional computer numerical control (CNC) machining. In the machining process, a diamond-like material, such diamond-like carbon (DLC), is used to process the aluminum alloy. However, some problems arise that negatively affect the machined surface quality and dimensional tolerance during the machining of these materials because the aluminum alloy is processed by pure mechanical activity (i.e., no electrochemical activity occurs.) For example, when an aluminum alloy which has a thin thickness is processed, a propagation of cracks present will inevitably occur due to grinding damage and residual stresses. In addition, cutting tool wear will also cause loss of time due to tool changing and machine tool adjustment requirements in machining operations. These problems may become more complex when variations in porosity and hardness of a workpiece to be processed are taken into consideration.

It would be desirable to develop methods of electrochemical removal that avoided some or all of the above-discussed problems.

### SUMMARY

One aspect of the present disclosure provides a workpiece processing system. The system includes a first grinding wheel configured to remove material from a workpiece in a first grinding process, comprising: a first conductive layer surrounding a first rotation axis of the first grinding wheel; and a plurality of grinding members positioned at an outer surface of the first conductive layer; a holding module configured to hold a workpiece; at least one electrolyte supply line configured to supply an electrolyte to the workpiece; an actuator assembly configured to drive at least one of a rotation of the first grinding wheel and a rotation of the holding module; and a power supply module configured to apply an electric current to the first conductive layer and the holding module.

In some embodiments, the grinding member is made of material consisting conductive metallic powder and non-conductive abrasive particles.

In some embodiments, the system further comprises a transducer connected to the fluid supply line to generate an ultrasonic energy to the electrolyte.

In some embodiments, the holding module comprises: a conductive base, wherein at least one fluid channel extends from a top surface to a bottom surface of the conductive base; and a conductive porous member positioned on the top surface of the conductive base, wherein the fluid channel of the conductive base is fluidly communicated with a vacuum source, and the workpiece is held on the conductive porous member via a vacuum force.

In some embodiments, the system further comprises a fluid conveying member configured to provide a fluid communication between the fluid channel of the conductive base and the vacuum source while the conductive base is rotated.

In some embodiments, the fluid conveying member comprises: a stationary housing comprising a plurality gas outlets; and a rotation shaft positioned in the stationary housing and rotatable with the conductive base and the conductive porous member, wherein a conduit is formed within the rotation shaft and is with one end fluidly communicated with the fluid channel of the conductive base and with the other end fluidly communicated with the gas outlets.

In some embodiments, the holding module further comprises: an electrode arranged around a rotation axis about which the conductive base rotates; and a plurality of electric contacts positioned between the electrode and the conductive base, wherein the electrode is kept stationary while the conductive base is rotated, and the electric current from the power supply module is applied to the conductive base via the electrode and the electric contacts.

In some embodiments, a top surface of the conductive base comprises a plurality of protrusions, and the conductive porous member comprises a plurality of grooves arranged relative to the protrusions.

In some embodiments, the conductive porous member is made of material selected from the group consisting of stainless steel, titanium alloy, and tungsten carbide.

In some embodiments, the system further comprises: an exhaust piping fluidly communicated with the holding module, wherein a vacuum source is connected to the exhaust piping; an electrolyte reservoir configured to store the electrolyte; a bypass piping fluidly communicated between the exhaust piping and the electrolyte reservoir; and a liquid regulating module operative in an operating mode and a rest mode, wherein in the operating mode, the liquid regulating module guides the fluid from the fluid channel to an ambient via the exhaust piping, and in the intermediate mode, the liquid regulating module guides the fluid from the fluid channel to the electrolyte reservoir via the exhaust piping and the bypass piping.

In some embodiments, the system further comprises: a supply piping fluidly communicated between the electrolyte reservoir and the electrolyte supply line; and a filtration module connected to the supply piping; wherein the electrolyte from the electrolyte reservoir is circulated back to the electrolyte supply line via the filtration module.

In some embodiments, the system further comprises a second grinding wheel configured to remove material from the workpiece in a second grinding process following the first grinding process, wherein the second grinding wheel comprises: a second conductive layer surrounding a second rotation axis of the second grinding wheel; and a plurality of second grinding members positioned at the outer surface of the second conductive layer.

In some embodiments, the first rotation axis is perpendicular to the second rotation axis.

In some embodiments, the workpiece is made of aluminum silicon carbide.

Another aspect of the present disclosure, a workpiece processing method is provided. The method includes loading a workpiece on a holding module; contacting a plurality of first grinding members of a first grinding wheel with a surface of the workpiece, wherein the first grinding members are arranged around a first rotation axis; applying an electric current to the workpiece and the first grinding wheel and supplying an electrolyte to a gap between the first grinding members and the workpiece so as to form an oxide layer on the surface of the workpiece; performing a first grinding process by rotating the first grinding wheel to remove the oxide layer; and adjusting the movement of the first grinding wheel or the supply of the electrolyte when a monitored parameter that is associated with thickness of the oxide layer is not within a range of a preset value.

In some embodiments, the method further comprises: replacing the first grinding wheel with a second first grinding wheel after the first grinding process is completed; contacting a plurality of second grinding members of the second grinding wheel with the surface of the workpiece, wherein the second grinding members are arranged around a second rotation axis different from the first rotation axis; applying another electric current to the workpiece and the second grinding wheel and supplying the electrolyte to a gap between the second grinding members and the workpiece so as to form another oxide layer on the surface of the workpiece; and performing a second grinding process by rotating the second grinding wheel to remove the another oxide layer.

In some embodiments, the workpiece is made of aluminum silicon carbide, and the first grinding wheel is configured to form features on the workpiece and the second grinding wheel is configured to trim the features.

In some embodiments, the monitored parameter is a rotation speed of the first grinding wheel, and when the rotation speed of the first grinding wheel is lower than a preset value, a flow rate of the electrolyte is increased.

In some embodiments, the monitored parameter is a pressure applied on the first grinding wheel, and when the pressure is greater than a preset value, a flow rate of the electrolyte is increased or a height of the first grinding member relative to the workpiece is decreased.

In some embodiments, the monitored parameter is an electric potential difference between the first grinding wheel and the workpiece, and when the electric potential difference is outside a range of value, a moving speed of the first grinding wheel is changed.

The above summary is not intended to describe each illustrated embodiment or every implementation of the present disclosure.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 shows a block diagram of a workpiece processing system, in accordance with one or more embodiments of the present disclosure.

FIG. 2 shows a schematic cross-sectional view of a workpiece processing system, in accordance with one or more embodiments of the present disclosure.

FIG. 3 shows a schematic view of a grinding wheel, in accordance with one or more embodiments of the present disclosure.

FIG. 4 shows a schematic view of a grinding wheel, in accordance with one or more embodiments of the present disclosure.

FIG. 5 shows a schematic cross-sectional view of partial elements of a holding module, in accordance with one or more embodiments of the present disclosure.

FIG. 6 shows a top view of a conductive support of the holding module of FIG. 5.

FIG. 7 shows a schematic view of a workpiece processing system, in accordance with one or more embodiments of the present disclosure.

FIG. 8 shows a schematic view of a flow stabilizing device, in accordance with one or more embodiments of the present disclosure.

FIG. 9 shows a schematic view of an electrolyte supply line, in accordance with one or more embodiments of the present disclosure.

FIGS. 10A and 10B show a flow chart illustrating a method for processing a workpiece made of aluminum alloy, in accordance with various aspects of one or more embodiments of the present disclosure.

FIG. 11 shows a schematic view illustrating the three different stages of a workpiece during a grinding process.

FIG. 12 shows a schematic view illustrating one stage of a method of performing a rough grinding process at which an oxide layer is adequately formed at a surface of the workpiece during the grinding process, in accordance with one or more embodiments of the present disclosure.

FIG. 13 shows a schematic view illustrating one stage of a method of performing a rough grinding process at which an abnormal is detected during the grinding process, in accordance with one or more embodiments of the present disclosure.

FIG. 14 shows a schematic view illustrating one stage of a method of performing a fine grinding process at which an oxide layer is adequately formed at a sidewall of a feature formed on the workpiece during the grinding process, in accordance with one or more embodiments of the present disclosure.

FIG. 15 is a waveform chart showing an example of current provided to a workpiece in a maintenance process, in accordance with one or more embodiments of the present disclosure.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

The terminology used in this specification is intended to describe particular embodiments and is not intended to be limiting. The terms “a,” “an,” and “the” include the plural forms as well, unless clearly indicated otherwise. The terms “comprises,” and/or “includes,” when used in this specification, specify the presence of the stated features, integers, steps, operations, elements, and/or components, but do not preclude the presence or addition of one or more other features, integers, steps, operations, elements, and/or components.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

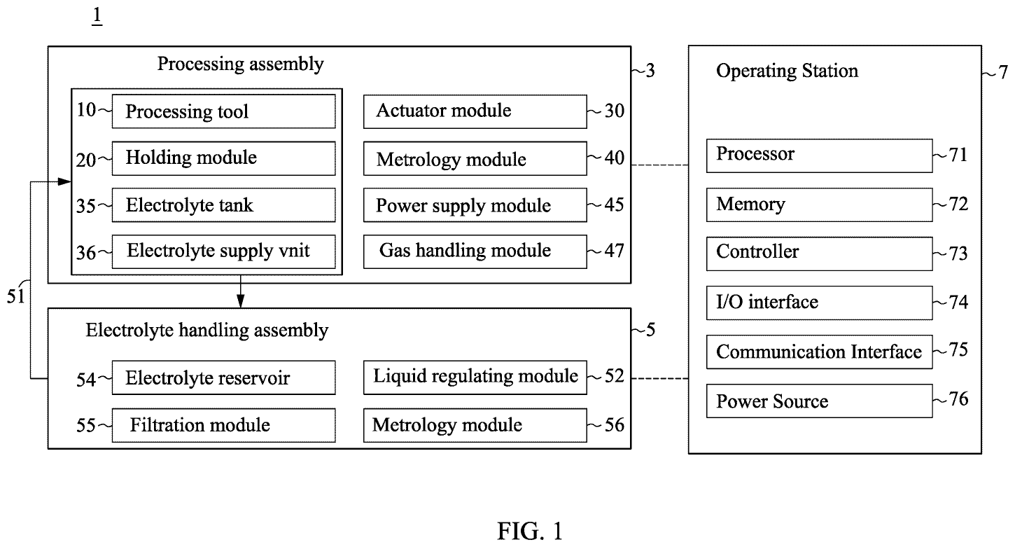

FIG. 1 shows a block diagram of a workpiece processing system 1, in accordance with one or more embodiments of the present disclosure. In accordance with some embodiments, the workpiece processing system 1 is configured to perform a grinding process over a workpiece by electrochemical grinding technique and includes a processing assembly 3, an electrolyte handling assembly 5 and an operating station 7. The workpiece to be processed in the present disclosure may be made of aluminum alloy such as aluminum silicon carbide (AlSiC) or the like. In some embodiments, the workpiece has a thickness of about 0.5 mm to about 20 mm, e.g., 0.7 mm, 2 mm, 5 mm, 7 mm, or 10 mm. In some embodiments, the workpiece has a thickness of is less than 0.7 mm. It should be appreciated that, while embodiments of present disclosure reveal a system for processing aluminum alloy, the disclosure should not be limited thereto. The system and method can be used to process any workpiece at which an oxidation reaction and/or reduction reaction can be activated in an electrochemical grinding process.

The processing assembly 3 is where fabrication takes place and contains a processing tool 10, a holding module 20, an actuator assembly 30, an electrolyte tank 35, at least one electrolyte supply line, such as electrolyte supply line 365, a metrology module 40, a power supply module 45 and a gas handling module 47. The electrolyte handling assembly 5 is used to process the electrolyte which is used in or to be supplied to the processing assembly 3 and includes a piping unit 51, a liquid regulating module 52, and an electrolyte reservoir 54, a filtration module 55, and a metrology module 56. The operating station 7 is used to control and monitor the operation of the processing assembly 3 and the electrolyte handling assembly 5. The operating station 7 may comprise a processor 71, a memory 72, a controller 73, an input/output interface 74 (hereinafter “I/O interface”), a communications interface 75, and a power source 76.

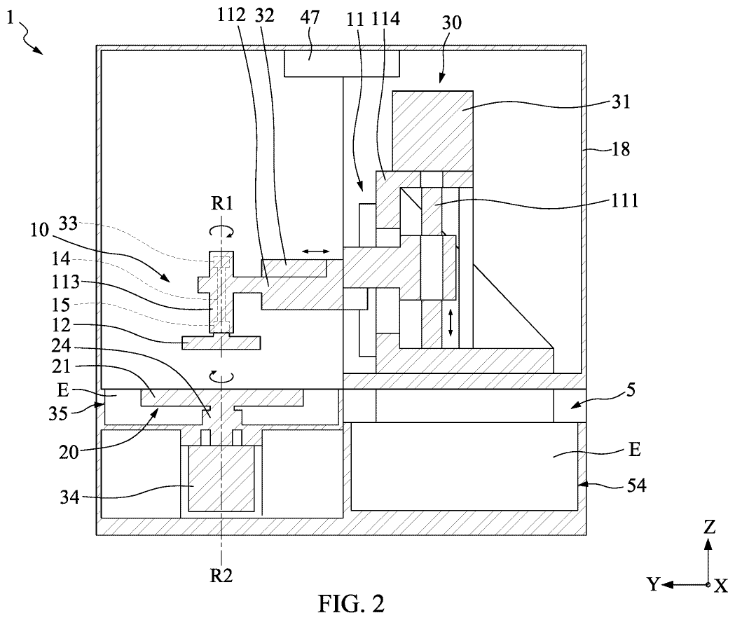

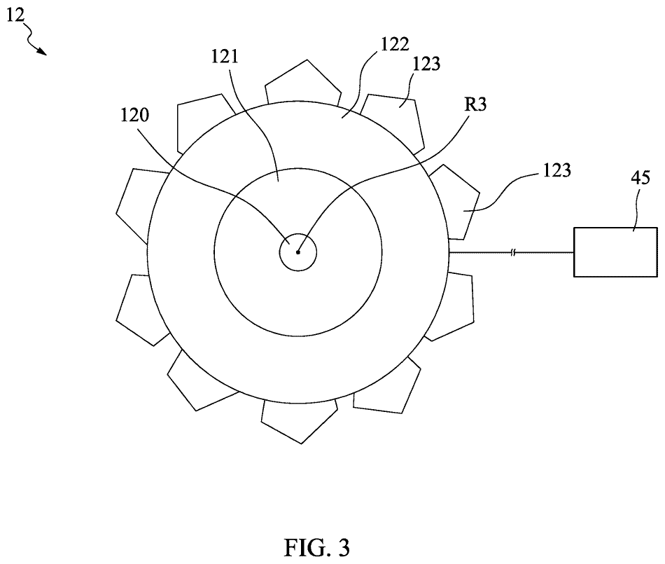

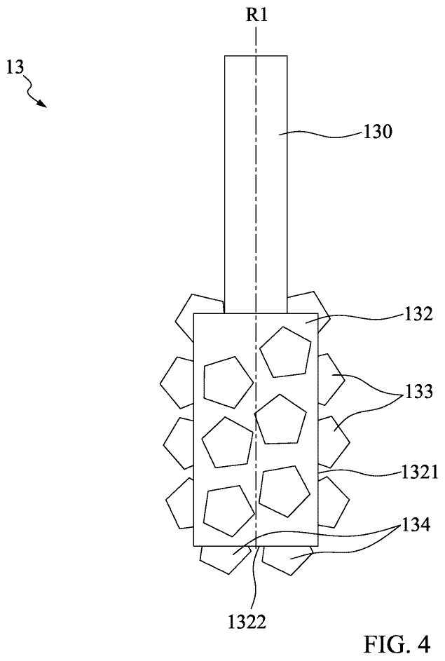

FIG. 2 shows a schematic cross-sectional view of the workpiece processing system 1, in accordance with one or more embodiments of the present disclosure. In some embodiments, the processing tool 10 includes a platform 11. The platform 11 is used to support a grinding wheel, such as first grinding wheel 12 shown in FIG. 3 or second grinding wheel 13 shown in FIG. 4. As shown in FIG. 2, in one exemplary embodiment, the platform 11 includes a frame 114, a horizontal arm portion 112 and a vertical arm portion 113. A first upper actuator 31 of the actuator assembly 30 is fixed on a top of a frame 114, and a ball screw 111 is connected to the first upper actuator 31 and extends within the frame 114 for driving a movement of the horizontal arm portion 112 in a vertical direction (Z-axis direction). In addition, a second upper actuator 32 of the actuator assembly 30 is fixed on the horizontal arm portion 112 to drive a movement of the vertical arm portion 113 in horizontal directions (X-axis and Y-axis directions). Furthermore, a third upper actuator 33 of the actuator assembly 30 is fixed on the vertical arm portion 113 to drive a rotation of the grinding wheel.

In some embodiments, a rotation axis 14 extends in the vertical arm portion 113. The third upper actuator 33 is connected to an upper end of the rotation axis 14 and configured to rotate the rotation axis 14 about a rotation axis R1. A lower end of the rotation axis 14 is connected to the first grinding wheel 12 or the second grinding wheel 13. In cases where the first grinding wheel 12 is connected to the rotation axis 14, bevel gears (not shown) may be connected between the first grinding wheel 12 and the lower end of the rotation axis 14. In operation, the power from the third upper actuator 33 is transmitted to the first grinding wheel 12 via the rotation axis 14 and the bevel gears so as to rotate the first grinding wheel 12 about a rotation axis R3 which is perpendicular to the rotation axis R1. In some embodiments, an attachment module 15 is fixed on the lower end of the rotation axis 14 and is positioned between the rotation axis 14 and the first grinding wheel 12 or between the rotation axis 14 and the second grinding wheel 13. The attachment module 15 is configured to facilitate the removably attachment of the first grinding wheel 12 or the second grinding wheel 13 to the rotation axis 14. The attachment module 15 may include any fastening mechanism, such as a snap, button, hook-and-loop fastener, and the like, to securely hold the first grinding wheel 12 or the second grinding wheel 13 while the rotation axis 14 rotates.

FIG. 3 shows a schematic view of the first grinding wheel 12, in accordance with one or more embodiments of the present disclosure. In some embodiments, the first grinding wheel 12 includes a first rotation axis 120, a base portion 121, a first conductive layer 122, and a number of grinding members 123. The first rotation axis 120 is connected to the rotation axis 14 (FIG. 2) and is rotatable around the rotation axis R3. The base portion 121 has a ring shape, and a center hole of the base portion 121 is coupled to the first rotation axis 120. The first conductive layer 122 surrounds the outer surface of the base portion 121. The first conductive layer 122 is formed with a conductive material, such as an alloy of cooper and tin, alloy of copper and nickel, alloy of coper and zinc, or the like. The base portion 121 insulates the first rotation axis 120 from the first conductive layer 122.

The grinding members 123 are fixed on the outer surface of the first conductive layer 122. In some embodiments, at least some of the grinding members 123 are conductive. For purpose of explanation, the grinding member 123 is referred to as conductive grinding member hereinafter. The grinding members 123 may be made of material consisting conductive metallic powder and non-conductive abrasive particles. The conductive metallic powder comprises powered cooper or powered tin, and the non-conductive abrasive particles comprises diamond, cubic zirconia or silicon carbide. In some embodiments, a ratio of a weight of the conductive metallic powder and a weight of the non-conductive abrasive particles is in a range of from about 2 to about 1 (i.e., 1:(1˜0.5)). The conductive grinding members 123 may be formed through a sintering process and are attached to the outer surface of the first conductive layer 122. The grinding members 123 may each include at least one acute angle end and may be formed with irregular shape. In operation, electric power from the power supply module 45 is transmitted to the conductive grinding members 123 through the first conductive layer 122 while the first grinding wheel 12 is rotated. A brush (not shown) may be electrically connected to a lateral surface of the first conductive layer 122 that is perpendicular to the rotation axis R3 to establish the electric connection between the first conductive layer 122 and the power supply module 45.

FIG. 4 shows a schematic view of the second grinding wheel 13, in accordance with one or more embodiments of the present disclosure. In some embodiments, the second grinding wheel 13 includes a second rotation axis 130, a second conductive layer 132, and a number of grinding members 133. The second rotation axis 130 is connected to the rotation axis 14 (FIG. 2) and is rotatable around the rotation axis R1. The second conductive layer 132 surrounds the second rotation axis 130. The second conductive layer 132 is formed with a conductive material, such as an alloy of cooper and tin, alloy of copper and nickel, alloy of coper and zinc, or the like. A base portion (not shown) may be formed between the second rotation axis 130 and the second conductive layer 132 and is used to insulate the second rotation axis 130 from the second conductive layer 132.

The grinding members 133 are fixed on the outer surface of the second conductive layer 132. In some embodiments, at least some of the grinding members 133 are conductive. For purpose of explanation, the grinding member 133 is referred to as conductive grinding member hereinafter. The grinding members 133 may be made of material consisting conductive metallic powder and non-conductive abrasive particles. The conductive metallic powder comprises powered cooper or powered tin, and the non-conductive abrasive particles comprises diamond, cubic zirconia or silicon carbide. In some embodiments, a ratio of a weight of the conductive metallic powder and a weight of the non-conductive abrasive particles is in a range of from about 2 to about 1 (i.e., 1:(1˜0.5)). The conductive grinding members 133 may be formed through a sintering process and are attached to the outer surface 1321 of the second conductive layer 132. The grinding member 133 may each include at least one sharp end and may be formed with irregular shape. In operation, electric power from the power supply module 45 is transmitted to the conductive grinding members 133 through the second conductive layer 132 while the second grinding wheel 13 is rotated. A brush (not shown) may be electrically connected to a top surface of the second conductive layer 132 that is perpendicular to the rotation axis R1 to establish the electric connection between the second conductive layer 132 and the power supply module 45.

Referring back to FIG. 2, the electrolyte tank 35 is configured to collect the electrolyte and the residuals produced during the grinding process. The electrolyte tank 35 may define a volume in which the holding module 20 is positioned. In addition, the electrolyte tank 35 has an open upper end to permit the insertion of the processing tool 10 into the electrolyte tank 35. In some embodiments, the workpiece processing system 1 further includes a protective housing 18. The processing tool 10, the holding module 20, and the electrolyte tank 35 are accommodated in a protective housing 18. A gas handling module 47 may be positioned on a top side of the protective housing 18 to exhaust particles, volatile gas, or splashing electrolyte from the protective housing 18. A negative pressure environment can be established in the protective housing 18 by the gas handling module 47.

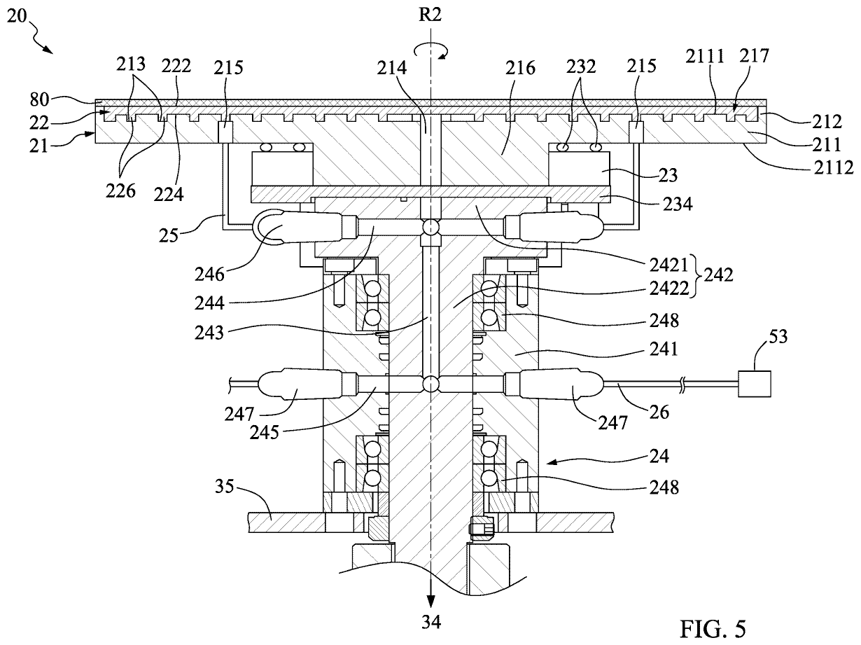

FIG. 5 shows a schematic cross-sectional view of partial elements of a holding module 20, in accordance with one or more embodiments of the present disclosure. The holding module 20 is configured to hold, position, and rotate a workpiece to be processed. In some embodiments, the holding module 20 includes a conductive support 21, a conductive porous member 22, and an electrode 23, and a fluid conveying member 24. The conductive support 21 allows a transmission of electric current from the electrode 23 to the conductive porous member 22. In some embodiments, the conductive support 21 includes a base 211, a flange 212, and a lower portion 216. The base 211 and the flange 212, and the lower portion 216 may be integrally formed with a conductive material, such as an alloy of cooper and tin. The base 211 is a circular plate, and the flange 212 is connected to a top surface 2111 of the base 211 and extends from a peripheral edge of the base 211 to form an accommodation space 217. The conductive porous member 22 is layered on the top surface 2111 of the base 211 and located within the accommodation space 217. The lower portion 216 is connected to a bottom surface 2112 of the base 211 and extends downward. The electrode 23 surrounds the lower portion 216 and electrically connected to the bottom surface 2112 of the base 211 through an electric contact 232, such as brush spring. Power from the power supply module 45 (FIG. 1) is provided to the conductive support 21 through the electrode 23. The electrode 23 is a stationary part when the holding module 20 is rotated.

In some embodiments, the conductive porous member 22 is formed on the conductive support 21 through a sintering process by placing conductive power, such as silicon carbide (SiC), into the accommodation space 217 and compacting the powder to form the shape of the conductive support 21. In some embodiments, metallic power may be mixed into the silicon carbide. However, the present invention is not limited to the embodiment. In one alternative embodiment, no metallic power is added in the conductive porous member 22, and the conductive porous member is made by pure silicon carbide. Addition of metallic power will advantagely increase the electrical conductivity but may decrease the porosity of conductive porous member 22. In some embodiments, the porosity of the conductive porous member 22 may be in a range of 10% to 40%. A lower porosity of the conductive porous member 22 results in an improvement of flatness of the ultra-thin wafer substrate while the wafer substrate is fixed on the conductive porous member 22 by a vacuum force. In one exemplary embodiment, the metallic power is made of material, which had high conductivity, selected from the group consisting of stainless steel, titanium alloy, and tungsten carbide. The conductivity (a) of the conductive porous member 22 may be in a range of 10⁻³˜10³ (S/cm).

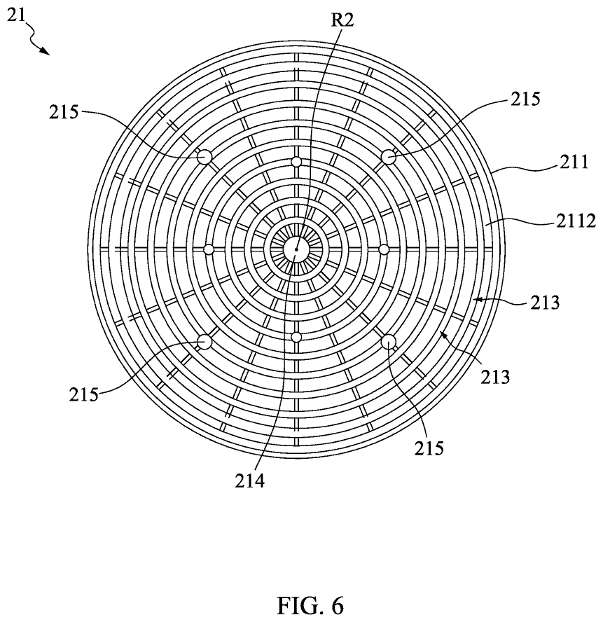

In some embodiments, the top surface 2111 of the base 211 is patterned to form a number of features so as to increase the contacting area between the base 211 and the conductive porous member 22 thereby improving the transmission of the electric current from the conductive support 21 to the conductive porous member 22. For example, as shown in FIG. 6, a number of grooves 213 are arranged concentrically around the rotation axis R2 and formed at the top surface 2111 of the base 211. In cases where the conductive porous member 22 is made by sintering process as mentioned above, the conductive porous member 22 have a shape which is conformal with the top surface 2111 of the base 211 which results in the formation of multiple protrusions formed on the bottom surface 224 of the conductive porous member 22. In addition, the top surface 222 of the conductive porous member 22 flash with the top free end of the flange 212. Therefore, the top surface 222 of the conductive porous member 22 and the top free end of the flange 212 cooperatively form a support surface to support the workpiece 80 during the grinding process.

In some embodiments, the workpiece 80 to be held by the holding module 20 is made of paramagnetic or diamagnetic materials and will not be attracted by a magnetic field. Therefore, in order to stably hold the workpiece 80, the workpiece 80 is fixed on the holding module 20 through vacuum force. To generate such vacuum force, a number of fluid channels are formed inside the base 211 to allow fluid from the supporting surface to be exhausted. For example, the base 211 includes a central fluid channel 214 and a number of peripheral fluid channels 215. The central fluid channel 214 and the peripheral fluid channels 215 each penetrates the base 211 and connected between the top surface 2111 and the bottom surface 2112 of the base 211. As shown in FIG. 6, the central fluid channel 214 is formed relative to the rotation axis R2, and the peripheral fluid channels 215 are arranged circumferentially on the base 211. In some other embodiments, the peripheral fluid channels 215 do not pass through the bottom surface 2112 of the base 211, but each extends horizontally and inwardly to connect the central fluid channel 214. The liquid from the peripheral fluid channels 215 diverges in the central fluid channel 214 first and then is delivered to the vacuum source via the fluid conveying member 24.

The fluid conveying member 24 is configured to provide a fluid communication between the fluid channel, such as central fluid channel 214 and peripheral fluid channels 215, of the base 211 and a vacuum source while the base 211 is rotated. In some embodiments, the fluid conveying member 24 includes a stationary housing 241 and a rotation shaft 242. The rotation shaft 242 extends axially inside the stationary housing 241 and connected to the inner wall of the stationary housing 241 through multiple bearings 248. A bottom end of the rotation shaft 242 is connected to a lower actuator 34 of the actuator assembly 30. The lower actuator 34 is configured to drive the rotations of the rotation shaft 242 and may be positioned below the electrolyte tank 35.

In some embodiments, the rotation shaft 242 has a T-shaped cross-section and includes a head portion 2421 and an axial portion 2422. The head portion 2421 is connected the upper end of the axial portion 2422 and has a diameter that is greater than a diameter of the axial portion 2422. The head portion 2421 is fixed to the lower portion 216 of the conductive support 21. An insulator 234 may be placed between the head portion 2421 and the lower portion 216 to insulate the fluid conveying member 24 from the conductive support 21.

An axial conduit 243 extends from the top surface of the head portion 2421 along the rotation axis R2 for a predetermined distance. The axial conduit 243 is fluidly connected to the central fluid channel 214. A number of upper lateral conduits 244 are radially extends in the head portion 2421. Each of the upper lateral conduits 244 includes an inner end connected to the axial conduit 243 and an outer end connected with an inlet port 246 formed at the lateral surface of the head portion 2421. The inlet ports 246 are fluidly connected to the peripheral fluid channel 215 through multiple connection lines 25. In addition, a number of lower lateral conduits 245 are radially extends in the axial portion 2422. Each of the lower lateral conduits 245 includes an inner end connected to a lower end of the axial conduit 243 and an outer end connected with an outlet port 247 formed at the lateral surface of the stationary housing 241. The outlet ports 247 are fluidly connected to the vacuum pump 53.

Through the fluid conveying member 24, fluid is allowed to be delivered from the supporting surface on which the workpiece 80 is placed to a vacuum source, such as vacuum pump 53, to expel the gas and/or liquid from the supporting surface even if the conductive support 211 is rotated. Specifically, when a vacuum is created by the vacuum pump 53, the fluid from the central fluid channel 214 is driven to flow through the axial conduit 243, the lower lateral conduits 245, and the outlet ports 247 sequentially and leave the holding module 20, and the fluid from the peripheral fluid channels 215 is driven to flow through the connection lines 25, the inlet ports 246, the upper lateral conduits 244, the axial conduit 243, the lower lateral conduits 245, and the outlet ports 247 sequentially and leave the holding module 20.

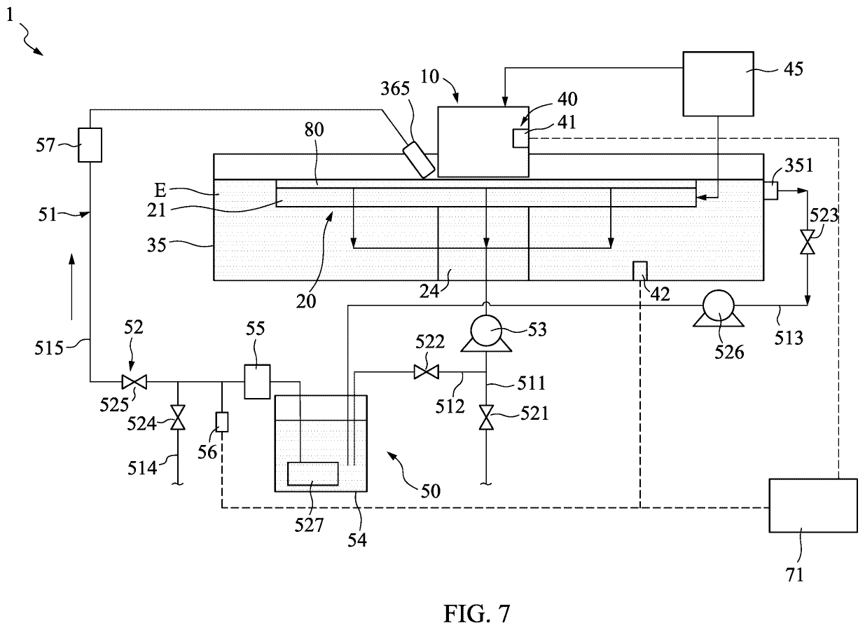

FIG. 7 shows a schematic view of the workpiece processing system 1, in accordance with one or more embodiments of the present disclosure. The piping unit 51 is used to deliver liquid in the workpiece processing system 1 and includes an exhaust piping 511, a bypass piping 512, a recycling piping 513, a drain piping 514, and a supply piping 515. The exhaust piping 511 is connected to the holding module 20 and is used to deliver gas exhausted from the holding module 20 in an operating mode. The bypass piping 512 is connected to the exhaust piping 511 and is used to deliver gas and electrolyte from the holding module 20 in a rest mode. The operating mode refers to a status of the holding module 20 in which the workpiece 80 is positioned thereon. The rest mode refers to a status of the holding module 20 in which the workpiece 80 is removed from the supporting surface. The recycling piping 513 is used to deliver the electrolyte from an outlet port 351 of the electrolyte tank 35 to the electrolyte reservoir 54. The supply piping 515 is used to deliver the electrolyte from the electrolyte reservoir 54 to the electrolyte supply line 365. The drain piping 514 is used to drain the waste electrolyte from the supply piping 515.

The liquid regulating module 52 is used to regulate the flow of the electrolyte or gas in the piping unit 51 in response to the signal from the controller 73 (FIG. 1) and includes multiple valves 521, 522, 523, 524, 525, a pump 526, and a submerged pump 527. The valve 521, the valve 522, the valve 523, the valve 524, and the valve 525 are respectively connected to the exhaust piping 511, the bypass piping 512, the recycling piping 513, the drain piping 514, and the supply piping 515 to control the flow in the piping. The pump 526 is used to actuate the flow in the recycling piping 513, and the submerged pump 527 is positioned in the electrolyte reservoir 54 to actuate the flow in the supply piping 515. In the operating mode, since the conductive porous member 22 is covered by the workpiece 80, no electrolyte will enter the exhaust piping 511, the controller 73 shuts off the valve 522 while keeps the valve 521 on so as to exhaust gas from the conductive support 21 to the ambient. In the rest mode, since the conductive porous member 22 is uncovered by the workpiece 80, electrolyte may enter the exhaust piping 511, the controller 73 shuts off the valve 521 while keeps the valve 522 on so as to expelled liquid and gas from the conductive support 21 to the electrolyte reservoir 54.

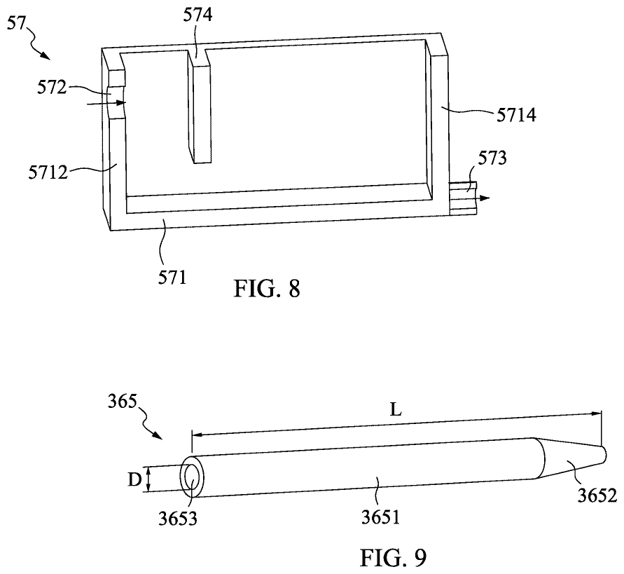

FIG. 8 shows a schematic view of a flow stabilizing device 57, in accordance with one or more embodiments of the present disclosure. In some embodiments, the liquid regulating module 52 may further includes a flow stabilizing device 57. The flow stabilizing device 57 includes a housing 571 having two opposite side walls 5712 and 5714. An inlet 572 is formed on the side wall 5712, and an outlet is formed on the side wall 5714. A blocking member 574 is positioned in the housing 571 and faces the inlet 572. The liquid regulating module 52 serves as a buffer tank to convert the flow from the electrolyte reservoir 54 to become steady flow before it enters the electrolyte supply line 365.

In some embodiments, electrolyte for facilitating an oxidation reaction and/or reduction reaction of the workpiece is dispensed through the electrolyte supply line 365. The electrolyte supply line 365 is connected to a downstream end of the supply piping 515. In operation, electrolyte from the electrolyte reservoir 54 is supplied to the electrolyte supply line 365 through the supply piping 515 and then is injected to a gap formed between the first or second grinding wheel 12 or 13 and the workpiece 80. In some embodiments, a transducer 17 is configured to excite the flow of electrolyte in the electrolyte supply line 365. The transducer 17 may surround the supply piping 515 and generate an ultrasonic energy so as to generate hydroxyl radicals, by electro-Fenton process, in the electrolyte when the electrolyte flows through the supply piping 515. With more hydroxyl radicals in the electrolyte, oxidation reaction or reduction reaction of the workpiece may be triggered easier without the application of electric current with a large voltage to the grinding member, which may adversely prolong the processing time of the grinding process.

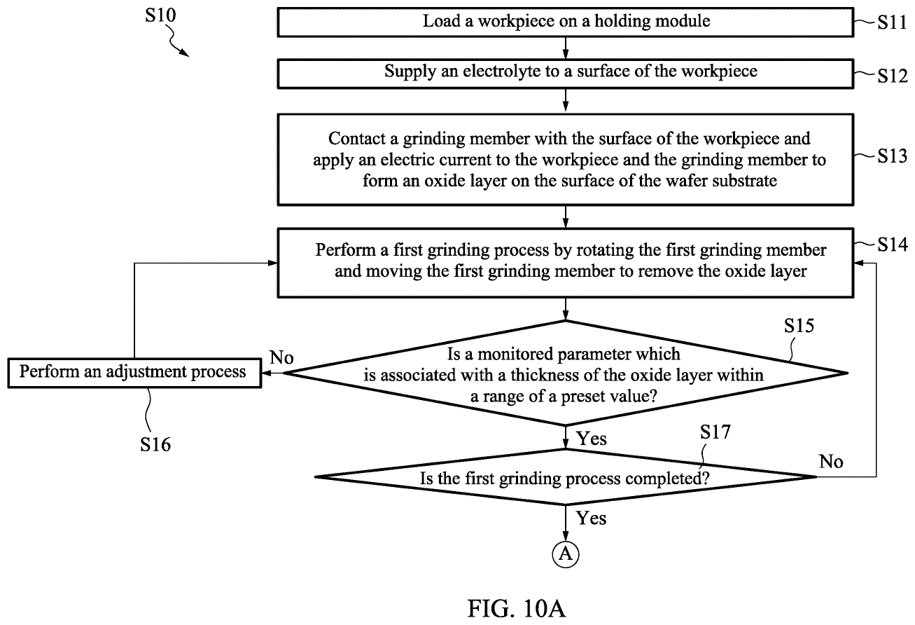

FIG. 9 shows a schematic view of the electrolyte supplying line 365, in accordance with one or more embodiments of the present disclosure. In some embodiments, the electrolyte supply line 365 includes an elongated body 3651 and a nozzle 3652. An end opening 3653 of the elongated body 3651 is connected to the supply piping 515 to receive the electrolyte from the supply piping 515. The nozzle 3652 is connected to an end of the elongated body 3651 that is opposite to the end opening 3653. A length L of the electrolyte supply line 365 may be 10 times greater than a diameter D of the end opening 3653 to promote laminar flow. The elongated body 3651 may be made with flexible element so as to adjust dispensing angle of the electrolyte while dispensing the electrolyte to the workpiece.

Referring back to FIG. 7, the metrology modules 40 and 56 are configured to monitor at least one parameter in the workpiece processing system 1 in real-time. In one embodiment, the metrology module 40 is positioned in the processing assembly 3 and can provide real-time monitoring of environmental parameters of the processing assembly 3. For example, the metrology module 40 includes a first sensor 41 positioned on the processing tool 10 and a second sensor 42 positioned in the electrolyte tank 35. The first sensor 41 may be used to detect parameters including a rotation speed of the first grinding wheel 12 or the second grinding wheel 13 of the processing tool 10, a compression pressure applied on the grinding wheel 12 or 13 of the processing tool 10, an electric potential difference between the grinding members 123 or 133 of the processing tool 10 and the workpiece 80. The second sensor 42 may be used to detect parameters including a flow rate of the electrolyte, a pH value of the electrolyte, a conductivity of the electrolyte. The metrology module 56 is positioned in the electrolyte handling assembly 5 and can provide real-time monitoring of environmental parameters of the electrolyte handling assembly 5. For example, metrology module 56 is connected at a downstream of the filtration module 55 to detect a concentration of contamination in the electrolyte. The measurement results produced by the metrology modules 40 and 56 are transmitted to the processor 71.

Referring back to FIG. 1, the processor 71 may comprise any processing circuitry operative to process the measurement data generated by the metrology modules 40 and 56 to determine whether an abnormal occur. In various aspects, the processor 71 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device.

In some embodiments, the memory 72 may comprise any machine-readable or computer-readable media capable of storing data, including both volatile/non-volatile memory and removable/non-removable memory which is capable of storing one or more software programs. The software programs may contain, for example, applications, user data, device data, and/or configuration data, archival data relative to the environmental parameter or combinations therefore, to name only a few. The software programs may contain instructions executable by the various components of the operating station 7. For example, memory 72 may comprise read-only memory (ROM), random-access memory (RAM), dynamic RAM (DRAM), disk memory (e.g., floppy disk, hard drive, optical disk, magnetic disk), or card (e.g., magnetic card, optical card), or any other type of media suitable for storing information. In one embodiment, the memory 72 may contain an instruction set stored in any acceptable form of machine readable instructions. The instruction set may include a series of operations after an abnormality is found in the workpiece processing system 1 based on the signals obtained by the metrology modules 40 and 56.

The controller 73 is configured to control one or more elements of the workpiece processing system 1. In some embodiments, the controller 73 is configured to drive the rotation of the grinding wheel 12 or 13 of the processing tool 10, the rotation of the holding module 20, and the flow of electrolyte in the piping unit 51. The controller 73 includes a control element, such as a microcontroller. The controller 73 issues control signals to the actuator assembly 30, the liquid regulating module 52, and the vacuum pump 53 in response to a command from the processor 71.

In some embodiments, the I/O interface 74 may comprise any suitable mechanism or component to at least enable a user to provide input to the operating station 7 or to provide output to the user. For example, the I/O interface 74 may comprise any suitable input mechanism, including but not limited to, a button, keypad, keyboard, click wheel, touch screen, or motion sensor. In some embodiments, the I/O interface 74 may comprise a capacitive sensing mechanism, or a multi-touch capacitive sensing mechanism (e.g., a touch screen). In some embodiments, the I/O interface 74 may comprise a visual peripheral output device for providing a display visible to the user. For example, the visual peripheral output device may comprise a screen such as, for example, a Liquid Crystal Display (LCD) screen.

In some embodiments, the communications interface 75 may comprise any suitable hardware, software, or combination of hardware and software that is capable of coupling the operating station 7 to one or more networks and/or additional devices (such as, for example, the actuator assembly 30, the liquid regulating module 52, and the vacuum pump 53.) The communications interface 75 may be arranged to operate with any suitable technique for controlling information signals using a desired set of communications protocols, services or operating procedures. The communications interface 75 may comprise the appropriate physical connectors to connect with a corresponding communications medium, whether wired or wireless. In some embodiments, the operating station 7 may comprise a system bus that couples various system components including the processor 71, the memory 72, the controller 73 and the I/O interface 74. The system bus can be any custom bus suitable for computing device applications.

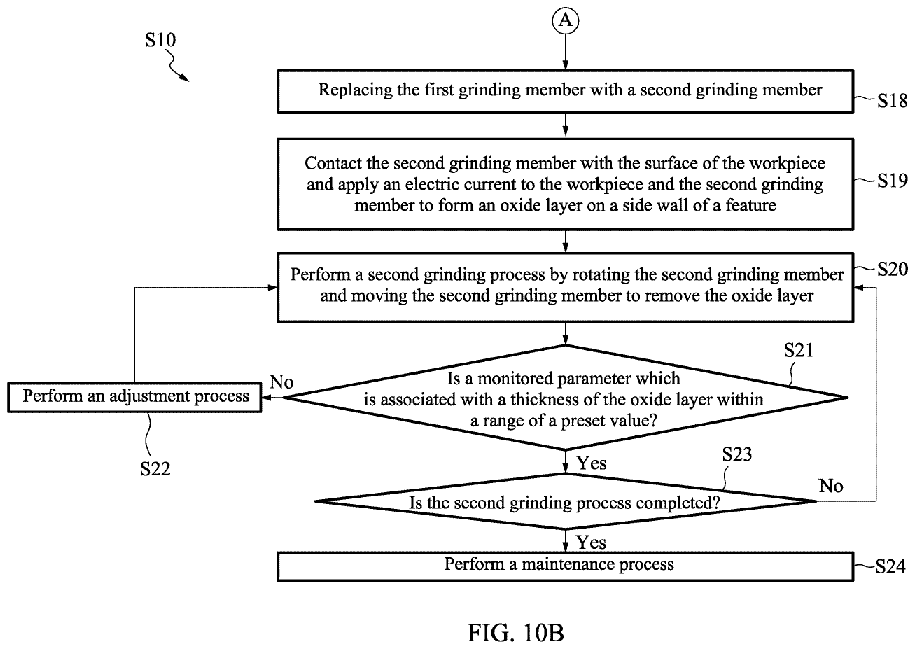

FIGS. 10A and 10B show a flow chart illustrating a method for processing a workpiece 80 made of aluminum alloy, in accordance with various aspects of one or more embodiments of the present disclosure. For illustration, the flow chart will be described along with the drawings shown in FIGS. 5, 7 and 11-15. Some of the described stages can be replaced or eliminated in different embodiments.

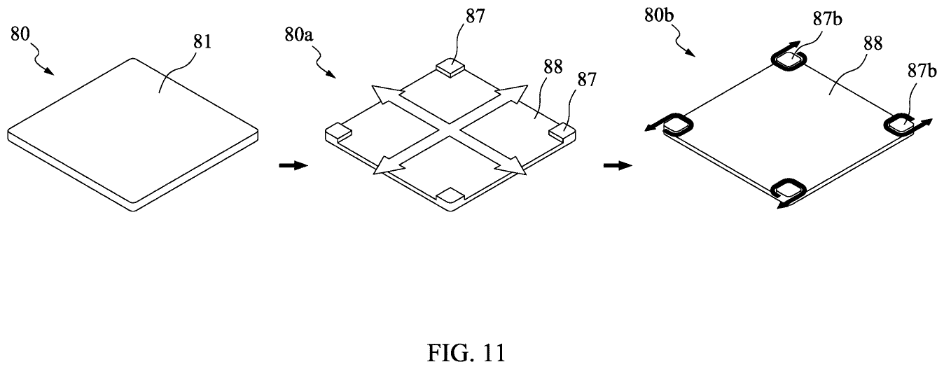

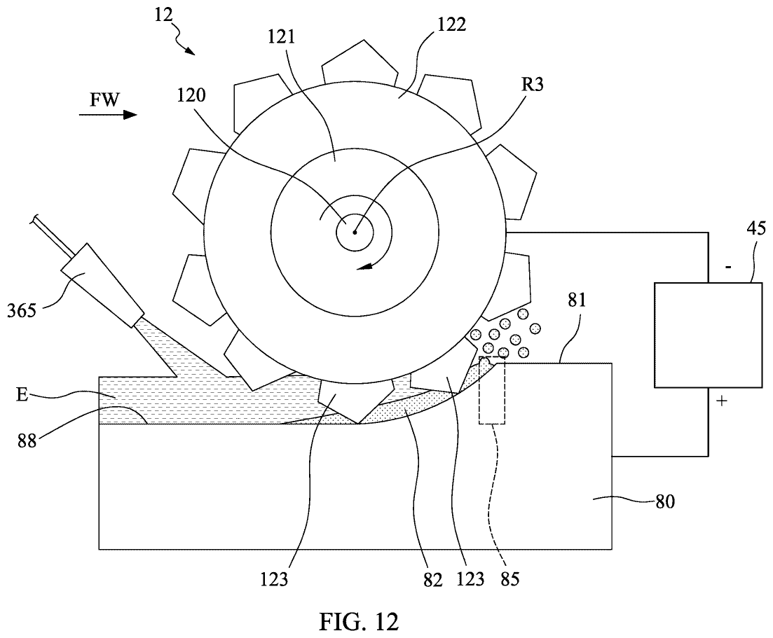

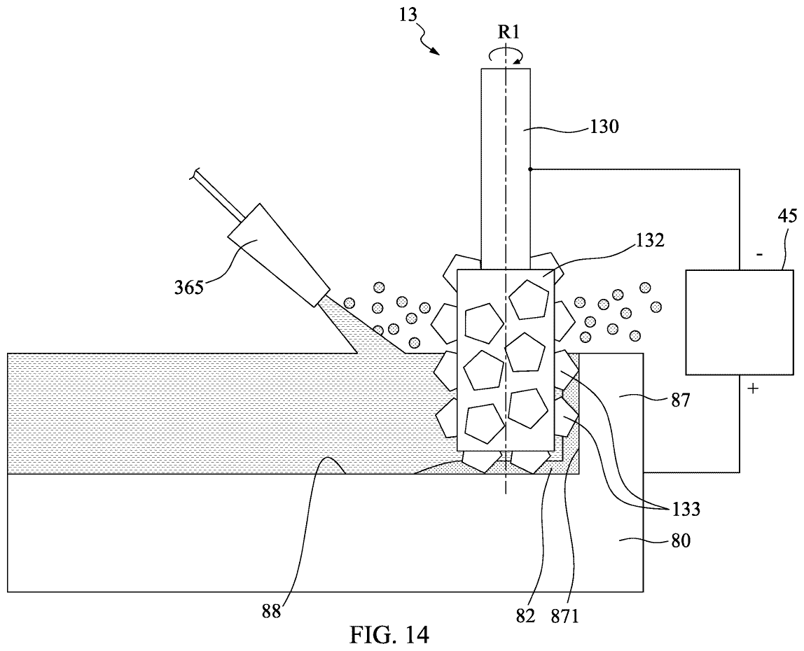

In some embodiments, as shown in FIG. 11, two processes are carried to form multiple features on the surface 81 of the workpiece 80. In the first process, the workpiece 80 may be grinded by the first grinding wheel 12 (FIG. 12) to form an intermediate product 80a. The first grinding wheel 12 is used to level large area of the workpiece 80 so as to form the intermediate product 80a which has a depressed region 88. In the second process, the workpiece 80 may be grinded by the second grinding wheel 13 (FIG. 14) to form a final product 80b. The second grinding wheel 13 is used to trim side walls of the features 87b to make them tidier. In accordance with some embodiments of present disclosure, the first process above is implemented by steps S11-S17 shown in FIG. 10A, and the second process above is implemented by steps S18-S23. Details of the first and second processes are provided below.

In step S11, a workpiece, such as workpiece 80, is loaded on the holding module 20. In some embodiments, when the workpiece 80 is loaded on the holding module 20, a vacuum force is created by the vacuum pump 53 to hold the workpiece 80. Since the vacuum force is evenly distributed over the entire top surface 222 of the conductive porous member 22, the workpiece 80 has a perfect surface flatness, after it is loaded on the holding module 20.

In step S12, an electrolyte is supplied to a surface of the workpiece 80. In some embodiments, the electrolyte may be supplied to the surface 81 of the workpiece 80 via the electrolyte supply line 365. The electrolyte E from the electrolyte supply line 365 is supplied to the surface 81 of the workpiece 80. In some embodiments, the first grinding wheel 12 along with the electrolyte supply line 365 are together moved along a forward direction FW, as indicated in FIG. 12. The electrolyte supply line 365 is positioned at a rear side relative to the first grinding wheel 12 in the forward direction FW. The electrolyte E is filled in the depressed region 88 of the workpiece 80 which has been processed by first grinding wheel 12, and then flows to a gap between the first grinding wheel 12 and the surface 81 of the workpiece 80. However, it will be appreciated that many variations and modifications can be made to embodiments of the disclosure. In some other embodiments, the electrolyte supply line 365 is positioned at a front side relative to the first grinding wheel 12 in the forward direction FW. The electrolyte E is directly supplied to a gap between the first grinding wheel 12 and the surface 81 of the workpiece 80 and then flows to the depressed region 88 of the workpiece 80 which has been processed by first grinding wheel 12. The electrolyte E drained from the workpiece 80 may be contained in the electrolyte tank 35 and then is circulated back to the electrolyte supply line 365 through the piping unit 51. The filtration module 55 is used to remove residues in the electrolyte E in the piping unit 51 to prolong the life time of the electrolyte E.

The electrolyte E may be a solution which includes commercially available electrolytes. For example, inorganic salt based electrolytes mixed with other component.

Additionally, embodiments of the disclosure contemplate using electrolyte compositions including rust inhibitors and chelating agents. In one aspect of the electrolyte solution, the electrolyte may have a temperature of 30-45° C. and a flow pressure of 35-70 KPa. The flow rate, the flow pressure, and flow volume are precisely controlled according to preset values which are determined according to empirically derived information or historic processing data.

In step S13, the grinding members 123 of the first grinding wheel 12 are moved to contact with the surface 81 of the workpiece 80, and an electric current is applied to the workpiece 80 and the grinding members 123. In some embodiments, the grinding members 123 are lowered down by the first upper actuator 31 (FIG. 2) to be in contact with the surface 81 of the workpiece 80. The power supply module 45 applies a direct current (DC) to the workpiece 80 and the grinding members 123 to form a bias between the workpiece 80 and the grinding members 123. In some embodiments, a positive bias is applied to the holding module 20, and a negative bias is applied to the processing tool 10 so that the workpiece 80 is served as an anode and the grinding members 123 is served as a cathode. Therefore, an oxidation reaction occurs at the surface 81 of the workpiece 80 when the electrons flows from the workpiece 80 to the grinding members 123 through the electrolyte E, and an oxide layer 82 is formed on the region of the surface 81.

In general, the power supply module 45 may be a constant-voltage power supply or a constant-current power supply and is capable of providing power between about 0 Watts and 100 Watts, a voltage between about 1V and 60V, and a current between about 0 amps and about 200 amps. In addition, the power supply module 45 may apply constant current or a periodic current pulse. The frequency of the periodic current pulse is lower than 2.5 KHz. The periodic current pulse may promote the formation of oxide layer on the workpiece. However, the particular operating specifications of the power supply may vary according to application.

In step S14, a first grinding process is performed by rotating and moving the grinding members 123 to remove the oxide layer 82 while the steps S12 and S13 last. In some embodiments, the grinding members 123 are rotated about the rotation axis R3 at a rotation speed of about 1000-5000 rpm, and the workpiece 80 is rotated about the rotation axis R2 (FIG. 7) at a maximum rotation speed of about 1000 rpm. The moving speed of the grinding members 123, or the processing tool 10, in the X-axis or the Y-axis direction, which is parallel to the surface 81 of the workpiece 80, is selected so that the amount of the material removed from the workpiece 80 is substantially the same as the amount of the oxide layer 82 formed on the workpiece 80.

In some embodiments, in a condition that the processing parameters are ideally controlled according to a preset values, the uppermost portion of a to-be-processed region 85 of the workpiece 80, which is located at the forward direction of the processing tool 10, may be oxidized before the grinding members 123 contacts this region, while the lower portion in the to-be-processed region 85 have not been oxidized. When the processing tool 10 moves to the to-be-processed region 85, the overall thickness (e.g., height of features 87 relative to the depressed region 88) of this region will be sufficient oxidized. Therefore, the grinding members 123 merely removes the oxide layer 82 through electrochemical activity. Since the hardness of the oxide layer 82 is remarkably less than that of the original material of the workpiece 80, the oxide layer 82 can be quickly and easily removed, and no, or merely a negligible, mechanical abrasion occurs. This advantagely leads to an extended life time of the grinding members 123, reduction in the amount of impurities in the electrolyte which may be produced during a mechanical abrasion, and successfully mitigates or avoids the generation of the residual stress and defects on the surface of the workpiece.

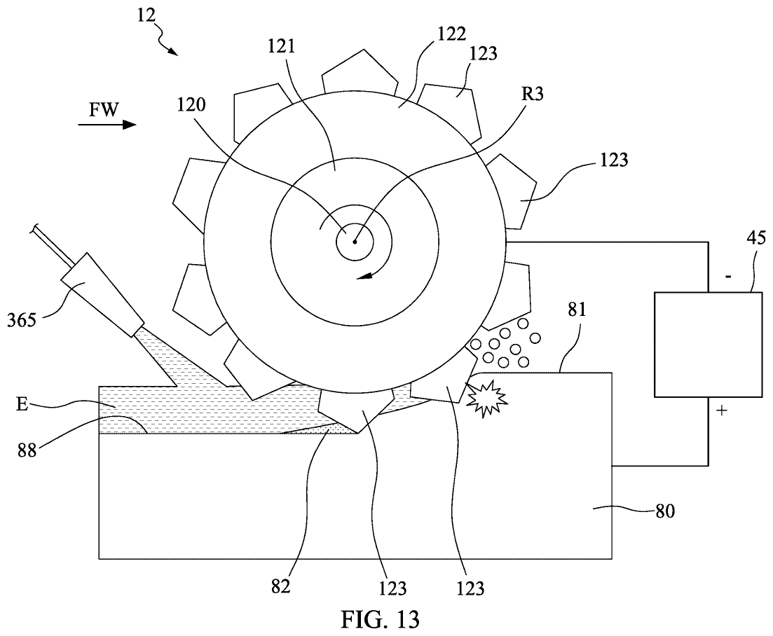

In some embodiments, as shown in FIG. 13, when abnormal occurs, the oxide layer 82 under the grinding wheel 12 may not be formed with desired thickness. If the thickness of the oxide layer 82 is less than that of the removal of material from the workpiece 80, a mechanical abrasion occurs between the grinding members 123 and the original material of the workpiece 80 which adversely decreases the processing quality and results in poor product yields. To address this issue, the process continues with step S15, in which a parameter which is associated with the thickness of the oxide layer is monitored, and the monitored parameter is compared with a preset value to determine if an abnormal occurs. If an abnormal is detected, the process continues with step S16 to conduct an adjustment process. One or more processing parameter may be modified in the adjustment process to improve the grinding quality.

Examples for controlling the system in response to the monitored parameter are provided as follows.

In some embodiments, the monitored parameter is a rotation speed of the grinding members 123. A decrease of the rotation speed of the grinding members 123 may indicate that the grinding members 123 is in contact with the non-oxidized material of the workpiece 80. To address this issue, the controller 73 may issue a control signal to the submerged pump 527 (FIG. 7) to increase the flow rate of the electrolyte so as to ensure the oxide layer 82 is formed with a predetermined thickness.

In some other embodiments, the monitored parameter is a pressure applied on the grinding members 123. A motor load sensor mounted on the third upper actuator 33 (FIG. 2) can be utilized to detect the pressure applied on the grinding members 123. An increase of the pressure may indicate that the grinding members 123 is in contact with the non-oxidized material of the workpiece 80. To address this issue, the controller 73 may issue a control signal to the submerged pump 527 (FIG. 7) to increase the flow rate of the electrolyte so as to ensure the oxide layer 82 is formed with a predetermined thickness. Alternatively, the controller 73 may issue a control signal to the first upper actuator 31 (FIG. 2) to adjust the feeding speed of the grinding members 123 in the Z-axis direction.

In still some other embodiments, the monitored parameter is an electric potential difference between the grinding members 123 and the workpiece 80. An increase of electric potential difference may indicate that the grinding members 123 is in contact with the non-oxidized material of the workpiece 80. To address this issue, the controller 73 may issue a control signal to the second upper actuator 32 (FIG. 2) to adjust the feeding speed of the grinding members 123 in the X-axis direction or in the Y-axis direction.

In still yet some other embodiments, a flow rate of the electrolyte, a conductivity of the electrolyte, or a pH value of the electrolyte is monitored by the metrology module 56. When the monitored parameter is outside a range of value, the controller 73 may pause the operation of the system, and replace the electrolyte including those in the electrolyte tank 35 and in the electrolyte handling assembly 5. Additionally or alternatively, the filtration module 55 may be replaced for a new one. After the replacement of the electrolyte, the first grinding process continues.

If no abnormal detects in step S15, the process continues with step S17 to determine if the grinding process is completed. In some embodiments, the grinding members 123 are arranged to move along a preset travel path. When processor 71 detects that the grinding members 123 are moved to an end point of the preset travel path, it determines the first grinding process is completed and continues with step S18. In step S18, the first grinding wheel 12 is replaced by the second grinding wheel 13. In some embodiments, the first grinding wheel 12 is manually detached from the attachment module 15, and the second grinding wheel 13 is coupled to the attachment module 15. In another embodiment, the first and second grinding wheels 12 and 13 are supported by different arms, and the first grinding wheel 12 and the second grinding wheel 13 are automatically exchanged by controlling the movement of the arms.

After the replacement of the grinding wheels, the process continues with step S19, in which the grinding members 133 of the second grinding wheel 13 are moved to contact with the surface 81 of the workpiece 80, and an electric current is applied to the workpiece 80 and the grinding members 133. In some embodiments, the grinding members 133 are lowered down by the first upper actuator 31 (FIG. 2) to be in contact with the surface 81 of the workpiece 80. The power supply module 45 applies a direct current (DC) to the workpiece 80 and the grinding members 133 to form a bias between the workpiece 80 and the grinding members 133. In some embodiments, a positive bias is applied to the holding module 20, and a negative bias is applied to the processing tool 10 so that the workpiece 80 is served as an anode and the grinding members 133 is served as a cathode. Therefore, an oxidation reaction occurs at the surface 81 of the workpiece 80 when the electrons flows from the workpiece 80 to the grinding members 133 through the electrolyte E, and an oxide layer 82 is formed on the side wall 871 of the feature 87 as shown in FIG. 14.

In general, the power supply module 45 may be a constant-voltage power supply or a constant-current power supply and is capable of providing power between about 0 Watts and 100 Watts, a voltage between about 1V and 60V, and a current between about 0 amps and about 200 amps. In addition, the power supply module 45 may apply constant current or a periodic current pulse. The frequency of the periodic current pulse is lower than 2.5 KHz. The periodic current pulse may promote the formation of oxide layer on the workpiece. However, the particular operating specifications of the power supply may vary according to application. Generally, during the first grinding process, the formation of oxide layer on the surface of the workpiece is accelerated by increasing the voltage and increasing the temperature of the electrolyte. At the same time, by reducing the speed of the grinding member and increasing the Z-axis feed speed of the rotation disc, a large amount of material can be quickly removed from the substrate. In contrast, during the second grinding process, the oxide layer is controlled to have a uniform thin thickness by reducing the voltage and the temperature of the electrolyte. At the same time, a dense surface is formed by increasing the rotational speed of the grinding member and reducing the Z-axis feed speed. In some embodiments, the grinding member used for the first grinding process is different from the grinding member used for the fine grinding member, wherein a grit size of the grinding member used for the first grinding process is greater than that used for the second grinding process.

In step S20, a second grinding process is performed by rotating and moving the grinding members 133 to remove the oxide layer 82 while the steps S12 and S19 last. In some embodiments, the grinding members 133 are rotated about the rotation axis R1 at a maximum rotation speed of about 30000 rpm, and the workpiece 80 is rotated about the rotation axis R2 (FIG. 7) at a maximum rotation speed of about 1000 rpm. The moving speed of the grinding members 133, or the processing tool 10, in the X-axis or the Y-axis direction, which is parallel to the surface 81 of the workpiece 80, is selected so that the amount of the material removed from the workpiece 80 is substantially the same as the amount of the oxide layer 82 formed on the workpiece 80.

To ensure the grinding process performed as desired, the process may include step S21, in which a parameter which is associated with the thickness of the oxide layer is monitored, and the monitored parameter is compared with a preset value to determine if an abnormal occurs. If an abnormal is detected, the process continues with step S22 to conduct an adjustment process. One or more processing parameters may be modified in the adjustment process to improve the grinding quality.

Examples for controlling the system in response to the monitored parameter are provided as follows.

In some embodiments, the monitored parameter is a rotation speed of the grinding members 133. A decrease of the rotation speed of the grinding members 133 may indicate that the grinding members 133 is in contact with the non-oxidized material of the side wall 871 of the feature 87. To address this issue, the controller 73 may issue a control signal to the submerged pump 527 (FIG. 7) to increase the flow rate of the electrolyte so as to ensure the oxide layer 82 is formed with a predetermined thickness.

In some other embodiments, the monitored parameter is a pressure applied on the grinding members 133. A motor load sensor mounted on the third upper actuator 33 (FIG. 2) can be utilized to detect the pressure applied on the grinding members 133 in the X-axis or the Y-axis direction. An increase of the pressure may indicate that the grinding members 133 are in contact with the non-oxidized material formed on the side wall 871 of the workpiece 80. To address this issue, the controller 73 may issue a control signal to the submerged pump 527 (FIG. 7) to increase the flow rate of the electrolyte so as to ensure the oxide layer 82 is formed with a predetermined thickness. Alternatively, the controller 73 may issue a control signal to the second upper actuator 32 (FIG. 2) to adjust the feeding speed of the grinding members 133 in the X-axis direction or in the Y-axis direction.

In still some other embodiments, the monitored parameter is an electric potential difference between the grinding members 133 and the workpiece 80. An increase of electric potential difference may indicate that the grinding members 133 are in contact with the non-oxidized material of the workpiece 80. To address this issue, the controller 73 may issue a control signal to the second upper actuator 32 (FIG. 2) to adjust the feeding speed of the grinding members 133 in the X-axis direction or in the Y-axis direction.

If no abnormal detects in step S21, the process continues with step S23 to determine if the second grinding process is completed. In some embodiments, the second grinding wheel 13 is arranged to move along a preset travel path along the side wall of each feature 87. When processor 71 detects that the second grinding wheel 13 is moved to an end point of the preset travel path, it determines the process is completed.

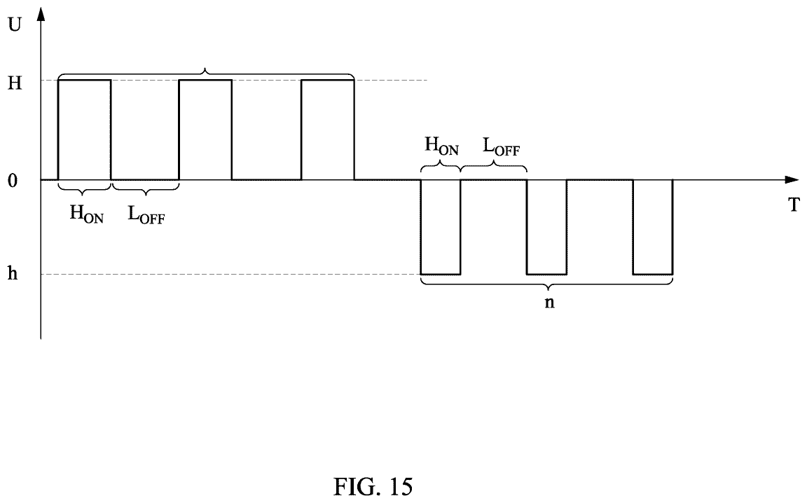

A maintenance process (step S24) may be performed after the completion of the workpiece grinding process or during the workpiece grinding process. In the maintenance process, the power supply module 45 applies alternate electric current to the grinding members 123 or the grinding members 133 and the workpiece 80. FIG. 15 schematically shows the current shape of wave supplied to the workpiece 80. In a grinding process the power supply module 45 provides the positive output to the workpiece 80 to drive the oxidation reaction into the surface of the workpiece 80. However, after a period of time of processing, impurities may be clogged within the grinding members 123 or 133, or the hardness or sharpness of the grinding members 123 or 133 may be degraded. To clean the grinding members 123 or 133, the power supply module 45 provides the negative output to the workpiece 80 and provides the positive output to the grinding members 123 or 133 to drive the oxidation reaction into the grinding members 123 or 133. Additionally, the grinding members 123 or 133 is driven to rotate relative to the workpiece. As a result, the impurities in the grinding members 123 or 133 can be removed from the grinding members 123 or 133 and/or the grinding members 123 or 133 can be sharpened. The period of time (Hon) of generation of the positive output and the period of time (hon) of generation of the negative output is in a range of 1 to 999.9 ms. The interval (Loff) between two consecutive positive outputs and the interval (Loff) between two consecutive negative outputs is in a range of 1 to 999.9 ms. The frequency of the positive outputs may be different from that of the negative outputs. The power supply module 45 provides a voltage between about −15V to 15V.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

1. A workpiece processing system, comprising:
a first grinding wheel configured to remove material from a workpiece in a first grinding process, comprising:
a first conductive layer surrounding a first rotation axis of the first grinding wheel; and
a plurality of grinding members positioned at an outer surface of the first conductive layer;
a holding module configured to hold a workpiece;
at least one electrolyte supply line configured to supply an electrolyte to the workpiece;
an actuator assembly configured to drive at least one of a rotation of the first grinding wheel and a rotation of the holding module; and
a power supply module configured to apply an electric current to the first conductive layer and the holding module.

2. The workpiece processing system of claim 1, wherein the grinding member is made of material consisting conductive metallic powder and non-conductive abrasive particles.

3. The workpiece processing system of claim 1, further comprising a transducer connected to the fluid supply line to generate an ultrasonic energy to the electrolyte.

4. The workpiece processing system of claim 1, wherein the holding module comprises:
a conductive base, wherein at least one fluid channel extends from a top surface to a bottom surface of the conductive base; and
a conductive porous member positioned on the top surface of the conductive base,
wherein the fluid channel of the conductive base is fluidly communicated with a vacuum source, and the workpiece is held on the conductive porous member via a vacuum force.

5. The workpiece processing system of claim 4, further comprising a fluid conveying member configured to provide a fluid communication between the fluid channel of the conductive base and the vacuum source while the conductive base is rotated.

6. The workpiece processing system of claim 5, wherein the fluid conveying member comprises:
a stationary housing comprising a plurality gas outlets; and
a rotation shaft positioned in the stationary housing and rotatable with the conductive base and the conductive porous member, wherein a conduit is formed within the rotation shaft and is with one end fluidly communicated with the fluid channel of the conductive base and with the other end fluidly communicated with the gas outlets.

7. The workpiece processing system of claim 4, wherein the holding module further comprises:
an electrode arranged around a rotation axis about which the conductive base rotates; and
a plurality of electric contacts positioned between the electrode and the conductive base, wherein the electrode is kept stationary while the conductive base is rotated, and the electric current from the power supply module is applied to the conductive base via the electrode and the electric contacts.

8. The workpiece processing system of claim 4, wherein a top surface of the conductive base comprises a plurality of protrusions, and the conductive porous member comprises a plurality of grooves arranged relative to the protrusions.

9. The workpiece processing system of claim 4, wherein the conductive porous member is made of material selected from the group consisting of stainless steel, titanium alloy, and tungsten carbide.

10. The workpiece processing system of claim 1, further comprising:
an exhaust piping fluidly communicated with the holding module, wherein a vacuum source is connected to the exhaust piping;
an electrolyte reservoir configured to store the electrolyte;
a bypass piping fluidly communicated between the exhaust piping and the electrolyte reservoir; and
a liquid regulating module operative in an operating mode and a rest mode, wherein in the operating mode, the liquid regulating module guides the fluid from the fluid channel to an ambient via the exhaust piping, and in the intermediate mode, the liquid regulating module guides the fluid from the fluid channel to the electrolyte reservoir via the exhaust piping and the bypass piping.

11. The workpiece processing system of claim 10, further comprising:
a supply piping fluidly communicated between the electrolyte reservoir and the electrolyte supply line; and
a filtration module connected to the supply piping;
wherein the electrolyte from the electrolyte reservoir is circulated back to the electrolyte supply line via the filtration module.

12. The workpiece processing system of claim 1, further comprising a second grinding wheel configured to remove material from the workpiece in a second grinding process following the first grinding process, wherein the second grinding wheel comprises:
a second conductive layer surrounding a second rotation axis of the second grinding wheel; and
a plurality of second grinding members positioned at the outer surface of the second conductive layer.

13. The workpiece processing system of claim 12, wherein the first rotation axis is perpendicular to the second rotation axis.

14. The workpiece processing system of claim 1, wherein the workpiece is made of aluminum silicon carbide.

15. A workpiece processing method, comprising:
loading a workpiece on a holding module;
contacting a plurality of first grinding members of a first grinding wheel with a surface of the workpiece, wherein the first grinding members are arranged around a first rotation axis;
applying an electric current to the workpiece and the first grinding wheel and supplying an electrolyte to a gap between the first grinding members and the workpiece so as to form an oxide layer on the surface of the workpiece;
performing a first grinding process by rotating the first grinding wheel to remove the oxide layer; and
adjusting the movement of the first grinding wheel or the supply of the electrolyte when a monitored parameter that is associated with thickness of the oxide layer is not within a range of a preset value.

16. The method of claim 15, further comprising:
replacing the first grinding wheel with a second grinding wheel after the first grinding process is completed;
contacting a plurality of second grinding members of the second grinding wheel with the surface of the workpiece, wherein the second grinding members are arranged around a second rotation axis different from the first rotation axis;
applying another electric current to the workpiece and the second grinding wheel and supplying the electrolyte to a gap between the second grinding members and the workpiece so as to form another oxide layer on the surface of the workpiece; and
performing a second grinding process by rotating the second grinding wheel to remove the another oxide layer.

17. The method of claim 16, wherein the workpiece is made of aluminum silicon carbide, and the first grinding wheel is configured to form features on the workpiece and the second grinding wheel is configured to trim the features.

18. The method of claim 15, wherein the monitored parameter is a rotation speed of the first grinding wheel, and when the rotation speed of the first grinding wheel is lower than a preset value, a flow rate of the electrolyte is increased.

19. The method of claim 15, wherein the monitored parameter is a pressure applied on the first grinding wheel, and when the pressure is greater than a preset value, a flow rate of the electrolyte is increased or a height of the first grinding member relative to the workpiece is decreased.

20. The method of claim 15, wherein the monitored parameter is an electric potential difference between the first grinding wheel and the workpiece, and when the electric potential difference is outside a range of value, a moving speed of the first grinding wheel is changed.
